(19) United States
(12) Patent Application Publication
(10) Pub. No.: US 2002/0053193 A1
(43) Pub. Date: May 9, 2002

(54) Diesel particulate filter unit

(75) Inventor: Takatoshi Sugano, Fujisawa-shi (JP)

Correspondence Address: STAAS & HALSEY LLP, 700 11TH STREET, NW, SUITE 500, WASHINGTON, DC, 20001, US

(73) Assignee: ISUZU CERAMICS RESEARCH INSTITUTE CO., LTD., Fujisawa (JP)

(21) Appl. No.: 09/866,762

(22) Filed: May 30, 2001

(30) Foreign Application Priority Data
Nov. 7, 2000 (JP) 2000-339075

(51) Int. Cl. B01D 46/00

(52) U.S. Cl. 55/498; 55/502

(57) ABSTRACT

In a diesel particulate filter unit 1 having a mat type filter member 15 which is laminated with inorganic fibers, a passing area altering means 30 is provided to alter the area of the exhaust gas G passing through the filter member 15 and the diesel particulate filter unit is so provided that a rise time of the trap efficiency can be shortened by speeding up it at the time of trap and after a high trap efficiency is obtained, PM trap can be continued with a high trap efficiency for a long time in preventing the filter from an increase of the pressurized damage.

### BACKGROUND OF THE INVENTION

1. Field of the Invention

The present invention relates to a diesel particulate filter (DPF) unit for trapping particulate matter (PM) in an exhaust gas of an internal combustion engine of a diesel engine and the like for cleaning the exhaust gas, and particularly to the diesel particulate filter unit in which an exhaust gas passing area is capable of changing.

2. Description of the Prior Art

Conventionally a diesel particulate filter (DPF) device is used for decreasing or eliminating particulate matter (PM) having a main composition of graphite which is included in an exhaust gas from a diesel engine of vehicles and the like.

For a filter of the device, there have been filters such as a filter of a porous honeycomb type cordierite, a filter formed by winding fibers on a porous metal cylinder, a filter using a porous metal, a filter using a fiber woven fabric, a filter using a metal mesh and a filter having a felt type inorganic fiber and the like.

These filters become clogging up after a continuous trap of PM, and the diesel particulate filter device is provided a plurality of filter units in general. One of filter units traps PM of the exhaust gas and is clogged up with the trapped PM, then the exhaust gas passage is changed to continue the trap of PM by the other filter unit and said clogged up filter unit is treated to recover. This conventional filter unit is shown in FIG. 14 and FIG. 15.

For recovering treatment of the filter, a exhaust gas pressure in the front and the rear of the filter unit is measured to estimate the amount of clogging up, namely the amount of trap of PM by an exhaust gas pressure thereof, and trapped PM is burned by raising the filter temperature over the PM burning initiation temperature.

The filter units include an electric heater respectively and PM is burned and treated by electric heating the electric heater of the object filter unit to be treated. During the treatment an air or a part of the exhaust gas is flowed to provide an oxygen for burning PM.

The outer area on the filter for filtration of the unit is formed in a large enough to clean the exhaust gas alternatively, that is enough to trap and clean particulate in the exhaust gas by only one of filter unit itself.

However immediately after recovering the filter, since PM have not been trapped enough to cover the relative rough mesh of the filter, the trap efficiency of PM from the initiation of trap to the end thereof (at the initiation of recovering) is not fixed and in a short time however after the initiation of trap, as shown by a dotted line of FIG. 13, the trap efficiency becomes deteriorate, and there is a problem to cause a fear of graphite visible from the exhaust tube outlet on the situation.

To overcome the problem, the filter is formed with fine mesh filter, however since the clogging caused by PM trap occurs in a short time and the problem that the trap time is shortened is happened.

It is an object of the present invention to overcome conventional problems and to provide a diesel particulate filter unit such that at the initiation of trap, the trap efficiency is urgently increased to shorten the rise time of the trap efficiency and at the time of obtaining high trap efficiency, the increasing of pressurized damage of the filter is prevented and PM trap can be continued for a long time with a high trap efficiency.

### BRIEF SUMMARY OF THE INVENTION

To achieve the object of the present invention, the diesel particulate filter (DPF) unit is comprised as follows;

1) In a diesel particulate filter unit comprising a mat type filter member laminated with inorganic fibers to trap particulate matter in an exhaust gas from a diesel engine, the diesel particulate filter unit includes a passing area changing means capable of altering an area which the exhaust gas passes through the filter member.

In accordance with the construction described hereinbefore, the passage area can be altered due to the clogging condition of the filter member and to a condition of the trap efficiency or the recovery of the filter and it is characterized that the best filtration area adequate for each condition can be selected.

2) In a diesel particulate filter unit, wherein said passing area changing means is provided to narrow the exhaust gas passing area for filtrating particulate at the initiation of the trap immediately after the recover of the filter and to enlarge the exhaust gas passing area continuously or step by step after the high trap efficiency of PM is obtained, further a control means is provided for making the exhaust gas passing area maximum at the time of recovering the filter.

In accordance with the construction described hereinbefore, at the initiation of the trap particulate immediately after recovering the filter, the trapped PM is clogged by a filtration in a narrow passing area to cover the rough mesh of the filter, and to increase the trap efficiency to shorten a rise time of the trap efficiency immediately after the recovery of the filter.

Further after a high trap efficiency is obtained, the increase of the pressurized damage of the filter is prevented by enlarging said passing area continuously or step by step to be capable of trapping PM with a high trap efficiency for a long time.

The increasing of the PM trap efficiency is measured by a changing of the exhaust pressure and a continuous time after starting the trap and the like, said passing area is enlarged due to these conditions. Further at the time of recovering the filter, the filter can be recovered in a short time by recovering the exhaust gas passing area to be maxim.

3) In a diesel particulate filter unit, the filter is bent in bellow shape in a manner of winding the one side of bent portion toward the outside of the cylinder, the other side thereof toward the inside of the cylinder and of winding the flat portion thereof to be radial with the center of the cylinder to form a hollow cylinder, said passing area changing means is disposed in said hollow portion of the filter and a movable inner cylinder is provided in the, filter capable of moving back and forth to the axial direction of the filter.

In accordance with the construction described hereinbefore, said passing area can be achieved by a relative simple construction.

4) In a diesel particulate filter unit, the filter is bent in bellow shape in a manner of winding the one side of bent portion toward the outside of the cylinder, the other side thereof toward the inside of the cylinder and of winding the flat portion thereof to be radial with the center of the cylinder to form a hollow cylinder, a passage shield plate is provided for said passing area changing means to include an uneven portion corresponding to a pleat shape of a bellow portion of the filter and to dispose in crossing with the axial direction of the filter and said passage shield is provided in the filter capable of moving back and forth to the axial direction of the filter.

The passage shield plate described hereinbefore is disposed vertically with the axis line of the filter in general, however it may be inclined and the passage area can be also achieved by such as relative simple construction.

5) In a diesel particulate filter unit, the filter is bent in bellow shape in a manner of winding the one side of bent portion toward the outside of the cylinder, the other side thereof toward the inside of the cylinder and of winding the flat portion thereof to be radial with the center of the cylinder to form a hollow cylinder, a passage shield tube is provided for said passing area changing means to include an uneven portion corresponding to a pleat shape of a bellow portion of the filter and to cover the periphery of the filter and filter and said passage shield tube is provided in the filter capable of moving back and forth to the axial direction of the filter.

In accordance with the construction described hereinbefore, the passage area can be also altered by a relative simple construction.

6) In a diesel particulate filter unit, the filter is bent in bellow shape in a manner of winding the one side of bent portion toward the outside of the cylinder, the other side thereof toward the inside of the cylinder and of winding the flat portion thereof to be radial with the center of the cylinder to form a hollow cylinder to be inserted in a case, a passage shutter is provided for said passing area changing means to include a plurality of openable shutter plates disposed on the side surface of the filter to partially cover the filter.

In accordance with the construction described hereinbefore, the passage area can be also altered by a relative simple construction.

### BRIEF DESCRIPTION OF THE DRAWINGS

FIG. 1 is a side sectional view of a first embodiment of a diesel particulate filter unit in accordance with the teachings of the present invention;

FIG. 2 is a partial front sectional view of the diesel particulate filter unit of FIG. 1;

FIG. 3 is a perspective view of a movable inner cylinder of FIG. 1;

FIG. 4 is a perspective view of multi-stage type movable inner cylinder;

FIG. 5 is a side sectional view of a second embodiment of a diesel particulate filter unit in accordance with the teachings of the present invention;

FIG. 6 is a partial front sectional view of the diesel particulate filter unit of FIG. 5;

FIG. 7 is a front view of a passage shutter of FIG. 5;

FIG. 8 is a side sectional view of a third embodiment of a diesel particulate filter unit in accordance with the teachings of the present invention;

FIG. 9 is a partial front sectional view of the diesel particulate filter unit of FIG. 8;

FIG. 10 is a front view illustrating a shape of a passage shield cylinder of FIG. 8;

FIG. 11 is a side sectional view of a fourth embodiment of the diesel particulate filter unit in accordance with the teachings of the present invention;

FIG. 12(a) is a partial front sectional view of the diesel particulate filter unit of FIG. 11 and FIG. 12(b) is a perspective view of the passage shutter;

FIG. 13 is a PM trapping efficiency of the diesel particulate filter unit;

FIG. 14 is a side sectional view of the diesel particulate filter unit of prior arts; and

FIG. 15 is a partial front sectional view of the diesel particulate filter unit of FIG. 14.

### DETAILED DESCRIPTION OF THE INVENTION

The embodiments of a diesel particulate filter unit in accordance with the present invention will be described hereinafter with reference to the drawings.

First parts common to each embodiment of the diesel particulate filter unit of the present invention will be described.

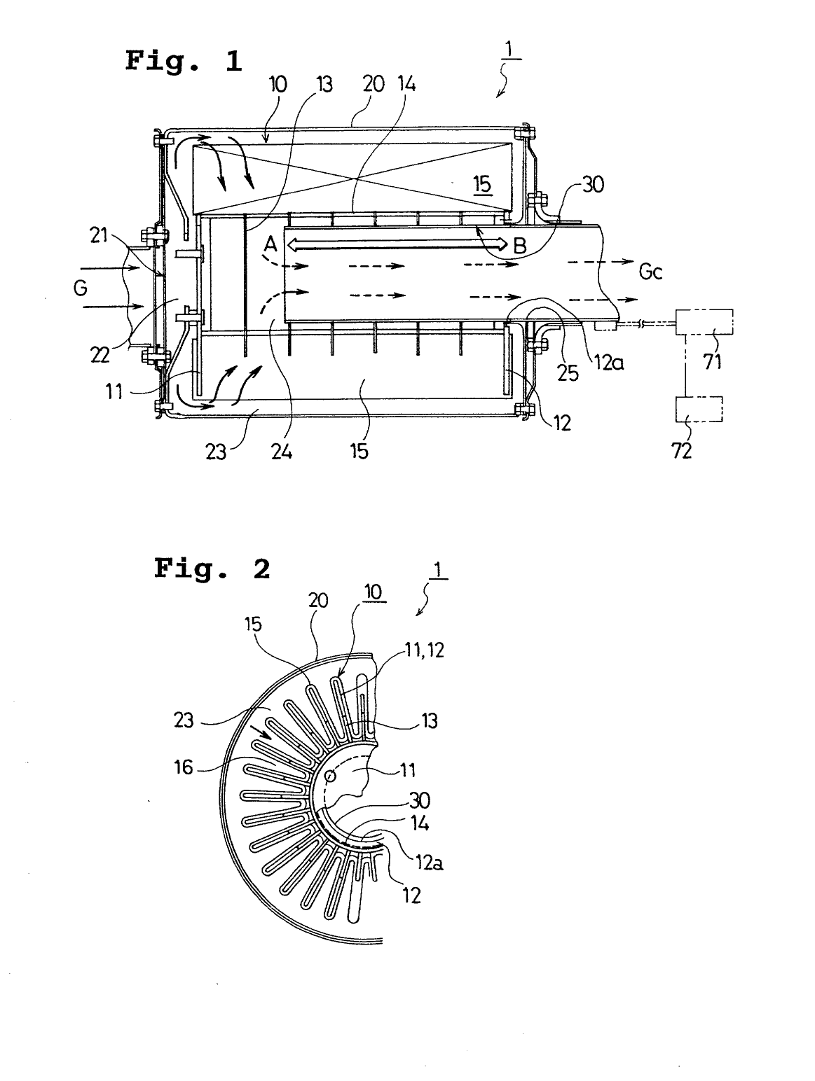

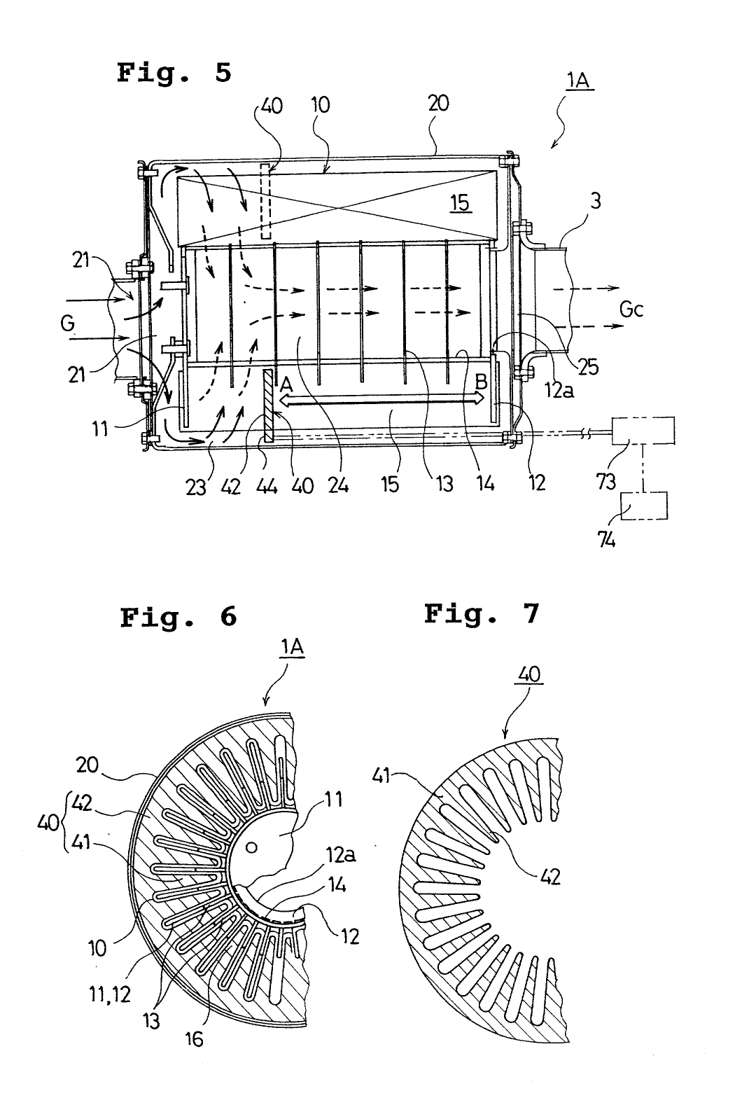

A filter member 15 illustrated in FIG. 1 and FIG. 5 is formed by laminating mat-type inorganic fiber felts having a rough structure, for example, laminated at random with a silicon carbide having 9 μm diameter and 50 mm length and having a dense structure laminated at random with a silicon carbide having 14 μm diameter and 50 mm length, thereafter both surfaces of laminated felts are held by a heat-resistant metal mesh having 0.3 mm and 15 mesh.

As illustrated in FIG. 2 and the like, the filter member 15 is bent to bellows against to frame bodies 11 to 14 to form a filter 10 in a manner of winding the one side of bent portion toward the outside of the cylinder, the other side thereof toward the inside of the cylinder and of winding the flat portion thereof to be radial with the center of the cylinder.

The frame bodies 11 to 14 include a petal shaped upstream side end member 11 and downstream side end member 12, a middle frame 13 to which center portion peripheral arm portions of a ring portion are protruded radially and a basket type side surface member 14 disposed in column to connect each member.

A radial arm portion is protruded to the upstream side end member 11, the downstream side end member 12 and the middle frame 13 and is held in the bellow type flat portion of the filter member 15, thereby a passage of cleaned gas Gc is prevented from contacting with the flat portion of adjacent filter member 15. Further the column type side surface member 14 serves as a support member to prevent a gas from flowing into the concave portion of the filter member 15 which is easy to receive a gas and easy into which PM is trapped.

With reference to design a size of the unit, for example, a thickness of the filter is about 7 mm, an outer diameter of the hollow type cylinder is 200 mm φ and a length thereof is 190 mm.

In the embodiment, a silicon carbide is used for an inorganic fiber, while the inorganic fiber such as alumina group, nitrogen silicon and mullite group is eligible.

Further the heat-resistant metal mesh to hold the felt is made of Fe—Al—Cr alloy at least including an iron, an aluminum and a chromium as an element and at least one of metal meshes is formed capable of being electricity. The electric metal mesh is used for a recovering heater to heat the filter member 15 which recovers and the filter 10 is heated by a current from the power source (not shown) at the time of recovering.

The First Embodiment

Further the first embodiment of the diesel particulate filter unit according to the present invention will be described referring to FIG. 1 to FIG. 4.

As illustrated in FIG. 1 and 2, the diesel particulate filter unit 1 of the embodiment includes a filter 10, a case 20 and a movable inner cylinder 30, the case 20 is provided with an opening 25 through which an exhaust gas inlet 21 and the movable inner cylinder 30 penetrate and the case 20 is disposed to surround the outer periphery of the filter 10.

The movable inner cylinder 30 includes a means capable of altering the area of the filter 10 into which the exhaust gas G passes, said cylinder is a circular tube to be disposed adjacent to the inside of the filter 10 such that one end opens toward a hollow portion 24 of the filter 10 and the other end opens to an exhaust passage(not shown), and the movable cylinder is formed to slide back and forth toward an axial direction of the cylindrical shape filter 10, that is A-B direction of FIG. 1 by a slide mechanism 71. The slide mechanism 71 can be composed of a cylinder device actuated by a motor or an air pressure.

As described hereinbefore, the present invention is characterized in that a kind of shutter mechanism is provided so that a central area of the filter relating to a funnel portion through which the exhaust gas passes and flows can be altered.

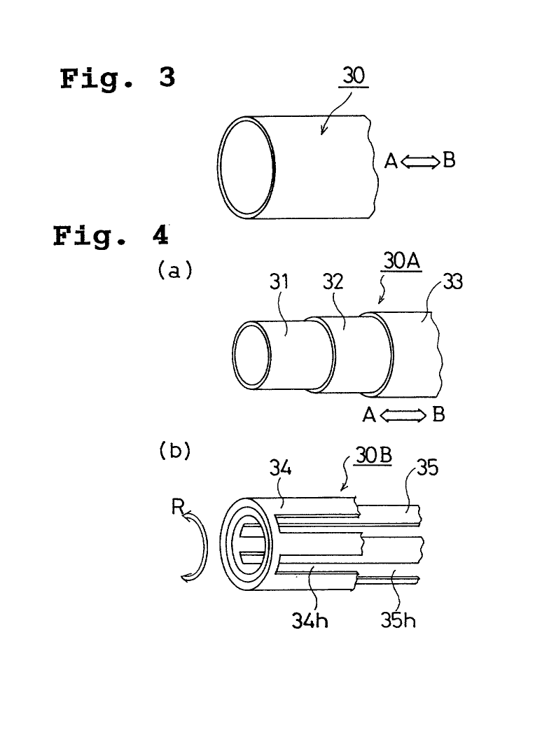

As illustrated in FIG. 3, the movable inner cylinder 30 may be formed by a single circular tube 30, while as illustrated in FIG. 4(a), the cylinder can be formed in a multi-stage type capable of piling up by laminating some circular tubes 31, 32, 33 . . . and can be altered the length thereof such as a zoom lens type. In this case, the minimum diameter circular tube 31 is moved toward B direction to be contained in a large diameter tube 32 one after another in order to be shortened continuously or step by step and the exhaust gas passage area is enlarged continuously or step by step.

Furthermore as illustrated in FIG. 4(b), an inner cylinder 3 having a slit 35h which extends to the axial direction is inserted in an outer cylinder 34 also having a slit 34h which extends to the same direction and both cylinders are rotated to the R direction correspondingly, thereby the exhaust gas passage area can be altered continuously. In this case, only a half of whole periphery of the cylinder is opened by laminating the slit 34h and the slit 35h, and it is necessary for opening full periphery of the cylinder to rotate both outer cylinder 34 and the inner cylinder 35 one after another or to move the cylinder toward the axial direction as same as the cylinder illustrated in FIG. 3.

In these structures, the exhaust gas G enters into the passage 23 disposed between the periphery of the filter 10 and the cylinder portion of the case 20 via the passage 22 outside of the upper stream end portion 11 of the filter 10 from the exhaust gas inlet 21 and is cleaned through the filter member 15 via the bellow type concave portion 16 from the filter 10 periphery.

Thereafter the cleaned Gas Gc is discharged to the outside such as a discharge tube (not shown) via the inside of the movable inner cylinder 30 from a hollow portion 24.

In a diesel particulate filter unit 1, at the start of trapping particulate immediately after recovering the filter 10, the movable cylinder 30 is slid and advanced to the position A as shown in FIG. 1 and particulate are filtrated in a narrow area at the front of the filter member 15, after the high trapping efficiency is obtained, the movable cylinder 30 is moved continuously or step by step to the B side as shown in FIG. 1 to enlarge the filtration area continuously or step by step, and at the time of recovering the filter, a control means 72 is provided to recover the filter so that the movable inner cylinder 30 is slid toward the B point in FIG. 1 in order to make the are where the exhaust gas passes maximum.

The timing of altering the gas passing area is based on the time passage from the start of trapping particulate and may be based on the exhaust gas pressure at the front and the rear of the filter 10, be based on an engine speed or a loading record or based on a change of operating condition of the engine.

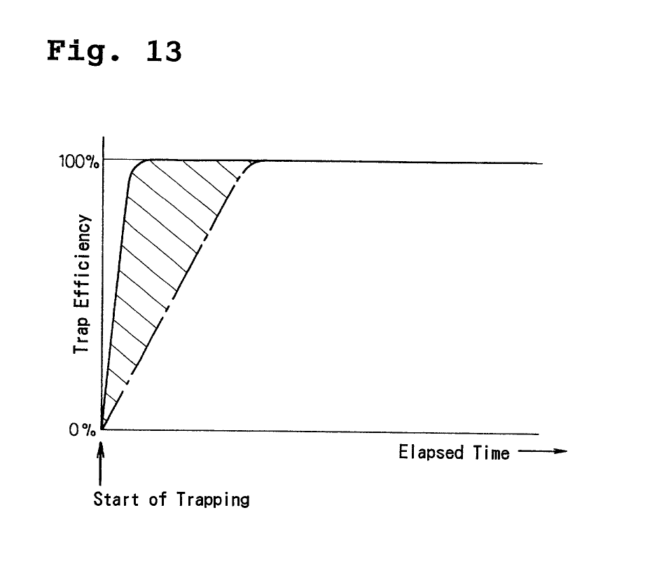

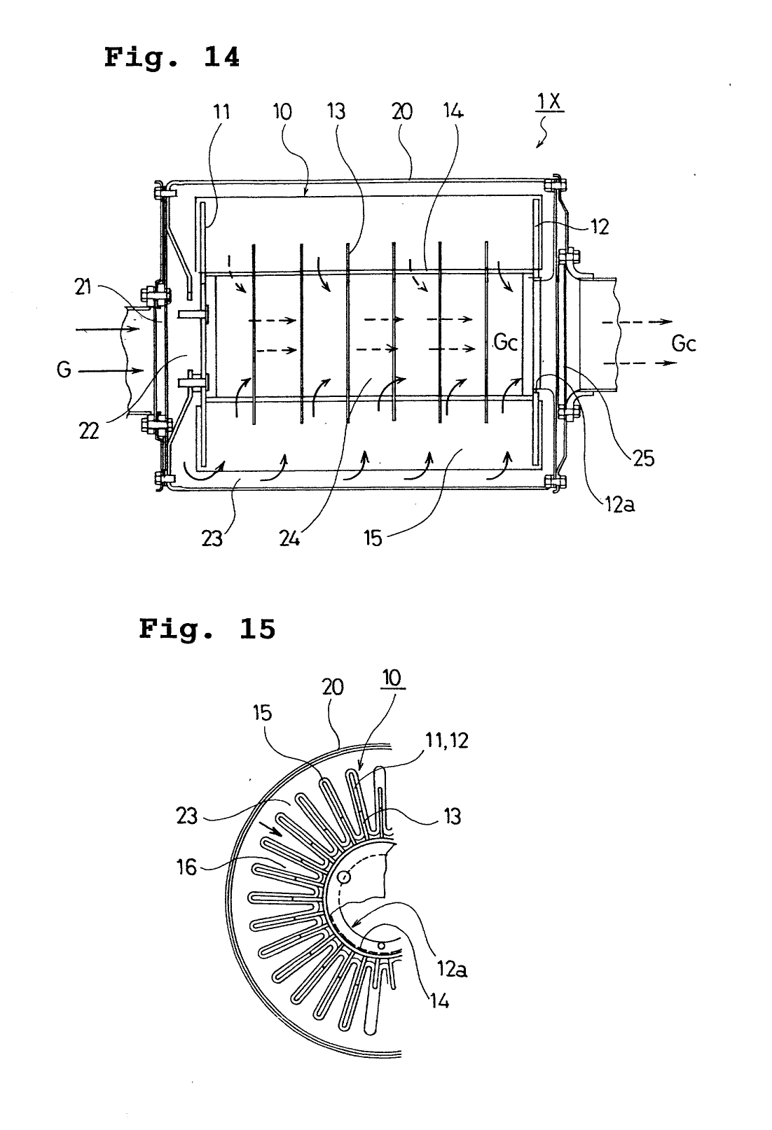

At the start of trapping particulate immediately after recovering, the PM trap is achieved in a narrow passing area, thereby the rough mesh of the filter can be covered by said traped PM to achieve a high trap efficiency as shown by a line of FIG. 13 to shorten a rise time of the trap efficiency immediately after the recovery.

After the high PM trapping efficiency is obtained, the passage area is enlarged continuously or step by step to prevent the filter from an increase of the pressure damage, thereby PM can be trapped for a long time with a high trap efficiency.

Furthermore at the time of recovering the filter, the exhaust gas passing area is enlarged to the maximum, thereby the filter can be recovered short time.

The Second Embodiment

As shown in FIG. 5 and FIG. 6, the second embodiment of the diesel particulate filter unit 1A includes a filter 10, a case 20 and a passage shield plate 40.

The passage shield plate 40 provides a means for altering said passing area capable of altering the area where the exhaust gas passes through the filter 10, as illustrated in FIG. 6 and FIG. 7, the shield includes an uneven portion corresponding to a pleat shape of a bellow portion of the hollow type filter 10, a circular annular portion 41 slid into the inside of the case 20 and a protrusion 42 penetrated into the pleat shape from the outside of the filter 10, the shield is disposed in a surface which is vertical with the axis line of the hollow cylinder type filter 10.

The shield is formed capable of moving back and forth to the axial direction of the hollow cylinder type filter 10, to the A-B direction of FIG. 5 by a slide mechanism 73 which can be composed of a cylinder device and the like to be actuated by a motor or an air pressure.

In these construction, the exhaust gas G flows into a bellow type concave portion 16 from the outer periphery of the filter 10 via an exhaust gas inlet 21, outside of the side end portion 11 of the filter 10, a passage 22 and a passage 23. The shield plate 40 is provided to cover the passage 23 and the concave portion 16 of the filter 10, thereby the gas G passes through the filter member 15 and is cleaned in an inlet side from the passage shield plate 40.

The cleaned gas Gc is discharged from a hollow portion 24 of the filter 10 and the exhaust passage 3 to the outside via an opening 12a of the frame 12 through an opening 25 of the case 20.

Also in this type diesel particulate filter unit 1A, a control device (control means) 74 is provided and at the start of trapping particulate immediately after recovering the filter 10, the shield plate 40 is slid to A point as shown in FIG. 5 to filtrate particulate matter in a narrow passage area, after high PM trapping efficiency is obtained, the shield plate 40 is moved continuously or step by step to B side of FIG. 5 to enlarge the filtration area continuously or step by step, and at the time of recovering the filter, the shield is slid toward the B point in FIG. 5 in order to make the area where the exhaust gas passes maximum.

The second embodiment of diesel particulate filter unit 1A can achieve the same effect of the first embodiment of the unit 1 by constructions described hereinbefore.

The Third Embodiment

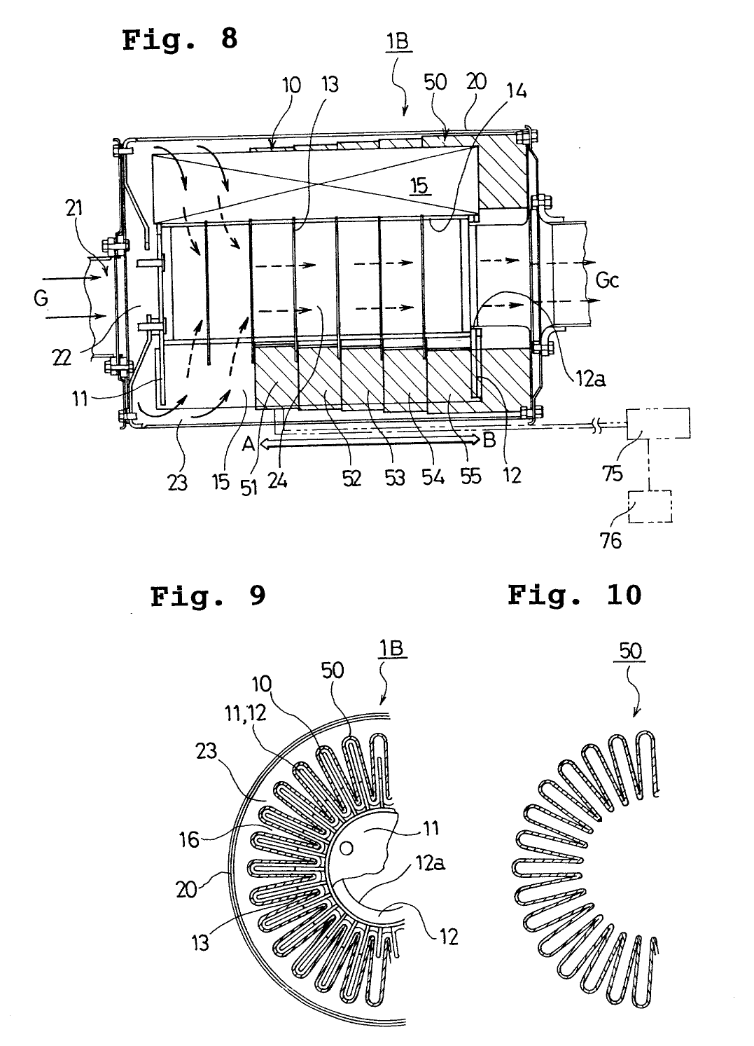

As shown in FIG. 8 and FIG. 9, the third embodiment of the diesel particulate filter unit 1B includes a filter 10, a case 20 and a passage shield cylinder 50.

The passage shield cylinder 50 (cover member) provides a means for altering said passing area capable of altering the area where the exhaust gas passes through the filter 10, as illustrated in FIG. 8 to FIG. 10, the shield includes an uneven portion corresponding to a pleat shape of a bellow portion of the hollow type filter 10, frame bodies 51 to 55 are multi-layered in said pleat shape of the filter 10 periphery to cover whole of the filter 10 and are disposed along the axis line of the hollow cylinder type filter 10 to form an elastic cover.

The shield cylinder is formed capable of moving back and forth to the axial direction of the hollow cylinder type filter 10, to the A-B direction of FIG. 8 by a slide mechanism 75 which can be composed of a cylinder device and the like to be actuated by a motor or an air pressure.

As shown in FIG. 8, the shield cylinder 50 may be formed in a multi stage type capable of laminating some cylinder bodies 51 to 55 and it is eligible to be formed in a structure by sliding only one cylinder.

In these construction, the exhaust gas G flows into a bellow type concave portion 16 from the outer periphery of the filter 10 via an exhaust gas inlet 21, outside of the upstream side end portion 11 of the filter 10, a passage 22 and a passage 23. The shield 50 is provided to cover the concave portion 16 of the filter 10, thereby the gas G passes through the filter member 15 and is cleaned in an inlet side from the passage shield 50.

The cleaned gas Gc is discharged from a hollow portion 24 of the filter and the exhaust passage 3 to the outside via an opening 12a of the frame 12 through an opening 25 of the case 20.

Also in this type diesel particulate filter unit 1B, a slide mechanism 75 and a control device (control means) 76 are provided and at the start of trapping particulate immediately after recovering the filter 10, the shield 50 is slid to A point as shown in FIG. 8 to filtrate particulate matter in a narrow passage area, after high PM trapping efficiency is obtained, the shield 50 is moved continuously or step by step to B side of FIG. 8 to enlarge the filtration area continuously or step by step. At the time of recovering the filter, the movement of the shield 50 is controlled to be slid toward the B point in FIG. 8 in order to make the area where the exhaust gas passes maximum.

The third embodiment of diesel particulate filter unit 1B can achieve the same effect of the first embodiment of the unit 1 by constructions described hereinbefore.

The Fourth Embodiment

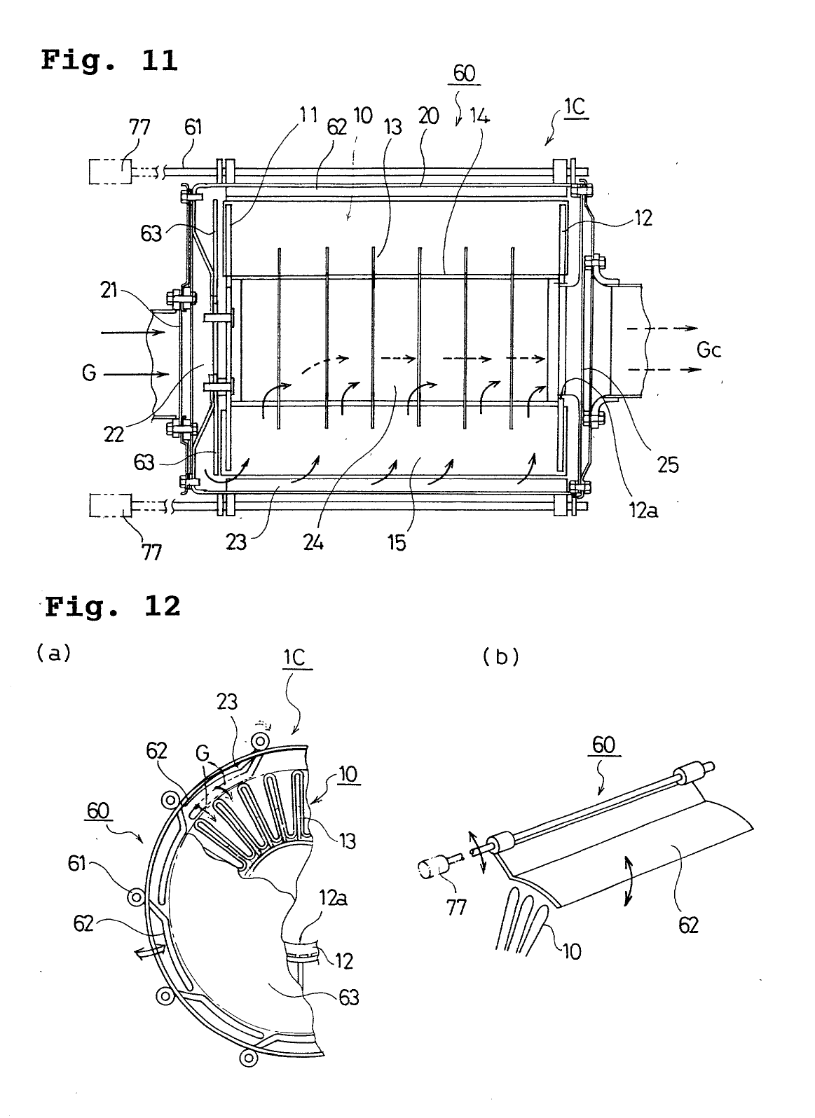

As shown in FIG. 11 and FIG. 12, the fourth embodiment of the diesel particulate filter unit 1C includes a filter 10, a case 20 and a passage shutter 60.

The passage shutter 60 provides a means for altering said passing area capable of altering the area where the exhaust gas passes through the filter 10, as illustrated in FIG. 11 and FIG. 12, the shutter includes a plurality of openable shutter plates 62 provided on the side surface of the filter 10 to partially cover the side portion of the hollow cylinder type filter 10.

The shutter 62 is rotated around a drive shaft 61 of the case by a cylinder device and the like which is actuated by a motor 77 or an air pressure and is formed capable of partially shielding between a passage 23 of the peripheral side of the filter unit 1C and the side surface of the filter 10.

It may achieve further effect to provide a shield disk 63 formed by a disk type member on the upstream side of the filter 10 to cover the inside area from the passage 23 in order to prevent the exhaust gas G from flowing directly to the concave portion 16 of the filter 10 from up stream of the filter.

In these construction, the exhaust gas G flows into the filter 10 from an exhaust gas inlet 21, via outside of the upstream side end portion 11 of the filter 10, a passage 22 and a passage 23 and the shutter 62 is provided to partially cover between the passage 23 and the side surface of the filter 10, thereby the gas passes flows into the filter side surface only from the passage 23 where the shutter 62 opens and is cleaned through the filter member 15.

The cleaned gas Gc is discharged from a hollow portion 24 of the filter and the exhaust passage 3 to the outside via an opening 12a of the frame 12 through an opening 25 of the case 20.

Also in this type diesel particulate filter unit 1C of the fourth embodiment, the same effect of the first embodiment of the unit 1 can be achieved by controlling each shutter 62 to open and close step by step for altering said passing area.

As should be understood upon review of the foregoing description, following effects can be achieved by a diesel particulate filter unit in accordance with the present invention.

A gas passing area of the filter unit to form the diesel particulate filter unit is capable of altering, thereby the rise time of the trap efficiency immediately after recovering the filter can be shortened since the trap efficiency can be increased by covering the rough mesh of the filter with trapped PM which is filtrated through a narrow passage area at the start of trapping immediately after the recovering.

Furthermore after a high PM trap efficiency can be obtained, said passing area is enlarged continuously or step by step to prevent the filter from the increase of the pressurized damage, thereby PM can be trapped with a high trap efficiency for a long time.

Still another, the filter can be recovered in a short time since said passing area of the exhaust gas can be recovered in maximum.

What is claimed is:

1. A diesel particulate filter unit comprising a mat type filter member laminated with inorganic fibers to trap particulate matter in exhaust gas from a diesel engine, characterized in that the diesel particulate filter unit includes a passing area changing means capable of altering an area in which the exhaust gas passes through the filter member.

2. A diesel particulate filter unit according to claim 1, wherein said passing area changing means is provided to filter by narrowing the exhaust gas passing area at an initiation of the trap immediately after recovering the filter and to enlarge the exhaust gas passing area continuously or step by step after the high trap efficiency of the particulate matter is obtained, further a control means is provided for recovering by making the exhaust gas passing area maximum when recovering the filter.

3. A diesel particulate filter unit according to claim 1 or 2, wherein the filter is bent into a bellow shape in a manner of winding one side of a bent portion toward an outside of a cylinder, the other side thereof toward an inside of the cylinder and of winding a flat portion thereof so as to be radial with a center of the cylinder to form a hollow cylinder, and said passing area changing means is constituted by disposing a movable inner cylinder in said hollow portion of the filter so as to move back and forth in an axial direction of the filter.

4. A diesel particulate filter unit according to claim 1 or 2; wherein
the filter is bent into a bellow shape in a manner of winding one side of a bent portion toward an outside of a cylinder, the other side thereof toward an inside of the cylinder and of winding a flat portion thereof so as to be radial with a center of the cylinder to form a hollow cylinder, said passing area changing means is constituted by disposing a passage shield plate having an uneven portion corresponding to a pleat shape of a bellow portion of the filter so as to cross with an axial direction of the filter and said passage shield plate is provided in the filter capable of moving back and forth in the axial direction of the filter.

5. A diesel particulate filter unit according to claim 1 or 2; wherein
the filter is bent into a bellow shape in a manner of winding one side of a bent portion toward an outside of a cylinder, the other side thereof toward an inside of the cylinder and of winding a flat portion thereof so as to be radial with a center of the cylinder to form a hollow cylinder, said passing area changing means is constituted by disposing a passage shield tube having an uneven periphery corresponding to a pleat shape of the bent portion of a bellow portion of the filter so as to cover a periphery of the filter, and said passage shield tube is provided in the filter capable of moving back and forth in an axial direction of the filter.

6. A diesel particulate filter unit according to claim 1 or 2; wherein
the filter is bent into a bellow shape in a manner of winding one side of a bent portion toward an outside of a cylinder, the other side thereof toward an inside of the cylinder and of winding a flat portion thereof so as to be radial with a center of the cylinder to form a hollow cylinder and to be inserted in a case, further said passing area changing means is constituted by disposing a passage shutter having a plurality of shutter plates for opening and closing a passage thereof disposed on a side surface of the filter to partially cover the filter.
